(19) United States
(12) Patent Application Publication
(10) Pub. No.: US 2017/0350635 A1
(43) Pub. Date: Dec. 7, 2017

(54) CONTAINER WITH PASSIVE TEMPERATURE CONTROLS

(71) Applicant: GOOGLE INC., Mountain View, CA (US)

(72) Inventor: Ilangovan Poonjolai Thirumurugavel, Milpitas, CA (US)

(21) Appl. No.: 15/174,582

(22) Filed: Jun. 6, 2016

(51) Int. Cl. F25D 3/08; F16K 17/04; F25D 17/00

(52) U.S. Cl. CPC F25D 3/08; F25D 17/00; F16K 17/04; F25D 2303/0845

(57) ABSTRACT

Delivering items to users by a delivery organization comprises a delivery container suitable to deliver items that require storage at a specific temperature range for the duration of the delivery. The delivery container may be a cube or a rectangular prism constructed of an insulating material. The delivery organization may position a panel in the delivery container to separate a chilled compartment from a compartment with a coolant. The panel between the compartments includes a pressure relief valve that opens when the pressure difference between the compartments reaches a set point. The open valve allows the chilled compartment to exchange air with the compartment with the coolant until the drop in the pressure difference allows the valve to close. The temperature in the chilled compartment is maintained in the desired range by the opening and closing of the valve.

### TECHNICAL FIELD

The present disclosure relates to improving the delivery of passively cooled products in segmented containers. The products in a particular compartment of the container are maintained at a particular temperature range through the use of a one-way pressure relief valve between a coolant compartment and the particular compartment.

### BACKGROUND

When shippers and other delivery companies ship products to users, the products often require cooling. For example, if a user orders dairy products from a grocery store for delivery, the products may require a container that maintains a temperature below a specified temperature to prevent spoilage. In some instances, certain products in an order require different amounts of cooling than other products. For example, an order from the grocery store may include dairy products that require a shipping temperature of 33-38 degrees F. and/or frozen items that require a shipping temperature of 0-20 degrees F. Delivery companies typically ship such items in different containers because of the different temperature requirements.

### SUMMARY

Techniques herein provide a delivery container for delivering items to users by a delivery organization. The delivery container is suitable to deliver multiple items that require storage at a specific temperature range for the duration of the delivery. The delivery container may be a cube or a rectangular prism constructed of an insulating material. The delivery organization may position a panel in the delivery container to separate a chilled compartment from a compartment with a coolant. The panel between the compartments includes a pressure relief valve that opens when the pressure difference between the compartments reaches a set point. The open valve allows the chilled compartment to exchange air with the compartment with the coolant until the drop in the pressure difference allows the valve to close. The temperature in the chilled compartment is maintained in the desired range by the opening and closing of the valve.

In certain other example aspects described herein, methods to prepare the container and select the coolant are provided.

These and other aspects, objects, features, and advantages of the example embodiments will become apparent to those having ordinary skill in the art upon consideration of the following detailed description of illustrated example embodiments.

### BRIEF DESCRIPTION OF THE DRAWINGS

FIG. 1 is an illustration depicting a cross section of a side view of a delivery container with a coolant compartment and a chilled compartment separated by a panel having a valve disposed therein, in accordance with certain example embodiments.

FIG. 2 is an illustration depicting a cross section of a valve in a closed state, in accordance with certain example embodiments.

FIG. 3 is an illustration depicting a cross section of the valve in an open state, in accordance with certain example embodiments.

FIG. 4 is an illustration depicting a cross section of a side view of a delivery container with a coolant compartment and two chilled compartments, with the compartments separated by panels that each have a valve disposed therein, in accordance with certain example embodiments.

### DETAILED DESCRIPTION OF EXAMPLE EMBODIMENTS

### Overview

The example embodiments described herein provide a segmented container wherein different segments of the container are maintained at different temperatures through the use of insulated barriers. In an example embodiment, a delivery organization receives an order to deliver one or more products to a user. In an example, the user has ordered products from a merchant to be delivered to the residence of the user. Alternatively, the delivery organization is the merchant and is delivering products sold by the delivery organization. Alternatively, the delivery organization receives products to ship from one user to a second user.

One or more of the products for delivery may require cooling to prevent spoiling, to ensure product stability, to provide a better user experience, or for any suitable reason. In the example, products in the delivery container require a temperature range that is above the temperature range created in a compartment with a coolant. In many of the examples herein, the products require cooling below ambient temperatures for delivery. However, in alternate examples, the products may require heating above ambient temperatures. Instead of coolants, the shipper may employ heating devices that will raise the temperature in the delivery container. In other examples, the coolants or other devices are provided to control other environmental factors, such as humidity.

In an example, one or more products require cooling to less than 38 degrees F., but above approximately 33 degrees F. The delivery organization configures a segmented container for shipping the group of products at the temperature range. Additionally, other products may be placed into one or more other compartments of the container. For example, frozen products may be placed into the compartment with coolant, and chilled products may be placed in a third compartment that is not cooled to a particular temperature. Any other suitable compartments or product temperatures may be utilized.

The size of the compartments may be varied by moving the panels that divide the compartments. The panels may be affixed to the walls of the container by any suitable means. For example, the wall of the container may have inset grooves into which the panels may slide or inserted via spring force and thus be affixed to the walls of the container. The grooves are set at regular intervals to allow the size of the compartments to be varied as needs arise. Alternatively, the wall of the container may have tabs, clips, or any other suitable connectors that may be used to affix the panel to the walls of the container. Alternatively, the panels may be constructed of multiple walls, such as four walls, that allow the panels to be self-supporting. That is, the panels may not require any connection to the walls of the container to divide the compartments. The compartments may be formed by stacking smaller containers inside the outside container.

The thickness and composition of the panels and the container vary between embodiments to allow for a preferred rate of heat transfer with the coolant. That is, the panels separating the compartments may be composed of a particular thickness of material (or multiple layers to achieve the desired thickness) to allow each compartment to be cooled to a particular temperature. In a preferred example, the panels are composed of cardboard or other recyclable material. Alternatively, the panels may be composed of any preferred material such as, polystyrene foam, cellulose, plastic, or any other suitable material.

The container and panels may be similarly composed of one or more materials to provide a required amount of insulation, rigidity, strength, or other required characteristics for the container. In an example, the container is composed of a cardboard outer shell with alternating layers of cardboard and plastic film inside the container walls. The term cardboard as used herein represents any recyclable or environmentally friendly material such as corrugated cardboard, cellulose, or any other material that is manufactured from a recyclable material or is itself recyclable. In an example, the panels are formed of airtight materials such as plastic, to prevent air from escaping from the compartments.

The delivery organization determines the type and/or amount of coolant needed to maintain the temperature in each compartment. The coolant required may be based on factors such as the mass and the thermal conductivity of the products in the compartments, the ambient temperature, the amount of time that delivery is expected to take, thickness of the panels and the container walls, the material of the panels and the container, the temperature of the items at the time of packing, and any other suitable factors. Based on these factors, the delivery organization selects an appropriate coolant and a particular amount of the coolant. A larger amount of coolant may cause a lower temperature to be maintained in each of the compartments, a temperature to be maintained for a longer period of time, or both. Certain coolants may cause the temperature to be lower than other coolants. For example, dry ice may cause the temperature to be lower than the temperature caused by water ice.

After segmenting the container into compartments and selecting the appropriate amounts of coolant, the delivery organization places the coolant in the delivery container. In the example, a particular type of coolant is placed in the bottom compartment of the container. In certain examples, the items requiring the lowest temperature storage are place in the compartment with the coolant. The delivery organization may place a tray or panel over the coolant to support the items in the next compartment.

The products are placed on the one or more trays or panels in the appropriate compartment of the container. The top of the delivery container is then affixed to the container to seal the container.

In other embodiments, the compartments are configured in a horizontal row instead of a vertical column. That is, the coolant may be on one side of the container, and the compartments are divided to be next to each other in a row.

In the panel between the coolant compartment and the chilled compartment maintaining the 33-38 degree temperature range, the delivery organization installs a pressure relief valve to maintain the temperature in the chilled compartment. The valve is typically a one-way valve that will open when the high pressure side has a pressure greater than the low pressure side. Typically, the pressure of the high pressure side must be more than a certain amount higher than the pressure of the low pressure side for the valve to open. For example, the pressure may only force the valve open when the high pressure side is 0.2, 1, or 5 pounds per square inch (“psi”) greater than the low side.

In the example, the coolant cools the chilled compartment to a lower temperature. The lower temperature may vary as the coolant melts, warms, evaporates, sublimates, or otherwise loses its cooling effect. In the example, if the coolant is water ice, the coolant compartment is cooled to less than 32 degrees F., such as 0 degrees F. In another example, if the coolant is dry ice, the coolant compartment is cooled to less than 0 degrees F., such as −20 degrees F. The thickness and insulating capacity of the panels and the container walls, as well as the amount and type of coolant(s) may be varied to dictate the temperature in each compartment.

As the coolant compartment temperature lowers and/or the environment causes the chilled compartment temperature to rise, the pressure difference between the coolant compartment and the chilled compartment increases. The pressure in each compartment is proportional to the temperature in each compartment. When the difference in the temperatures of the two compartments increases, the difference in the pressures of the two compartments increases proportionally. When the pressure difference is greater than the set point of the valve, the valve is forced open by the pressure difference.

For example, the valve may include a spring operated seal to prevent air flow when closed. That is, the spring forces the valve closed to prevent air from flowing through the valve. When the pressure difference is greater than the set pressure of the spring, the valve is forced open and air flows through the valve. When the air flows from the high pressure side of the valve to the low pressure side of the valve and the pressure equilibrates or the pressure difference otherwise drops below the set point of the valve, the spring forces the valve to close. Alternate valves may not use a spring to close the valve and the valve closes by another means. For example, the valves may use a gasket or other material to seal the valve and open under pressure.

When the temperature in the chilled compartment rises to a desired temperature, the pressure proportionally rises to that desired pressure and forces open the valve. When open, the valve allows air to flow through the valve. Initially, the air from the chilled compartment flows through to the coolant compartment reducing the pressure and thus the temperature of the chilled compartment. As the valve typically takes some amount of time to reclose, a flow of cooler air from the coolant compartment may flow into the chilled compartment and exchange heat with the air in the chilled compartment causing the chilled compartment temperature to further cool. When the pressure in the chilled compartment decreases, the temperature in the compartment will experience a proportional decrease in temperature.

When the pressure of the chilled compartment reaches an equilibrium with the coolant compartment, or drops below the set pressure of the valve, the valve closes. The temperature of the chilled compartment has been chilled to a desired temperature based on the speed of the closure of the valve. A faster closing valve will allow a smaller exchange of air and heat between the compartments and a lesser reduction in the heat of the chilled compartment. A valve that takes a longer time to close will allow for a greater exchange of air and will cause the temperature in the chilled compartment to be cooled to a relatively lower temperature.

In testing certain embodiments, a valve allows control of a temperature range in the chilled compartment of about 4 to 5 degrees F. That is, the temperature when the valve opens is about 4 to 5 degrees higher than after the valve closes. For example, the temperature of the chilled compartment may be maintained for an extended period of time between 33 and 38 degrees F.

In another example, the container may have multiple cooled compartments, such as a compartment for the coolant, a compartment for frozen items, and a compartment for refrigerated items. The container may include two valves for maintaining the temperature in each respective compartment. For example, a valve between a coolant compartment and the first compartment may maintain the temperature of the first compartment at 0-6 degrees F. A second valve between the first compartment and the second compartment maintains the temperature in the second compartment at 33-38 degrees F. The two valves in this configuration operate substantially the same as the examples herein using a single valve.

The container is delivered to the user in any suitable manner, such as by the delivery organization itself, a delivery service, a postal service, a courier, or any other suitable delivery organization or person. The user receives the delivery container and removes the items for use or storage.

By using and relying on the methods and systems described herein, the user may receive a container that contains products that are maintained at a specific temperature range. As such, the systems and methods described herein may allow products to be shipped that would otherwise be at risk or spoilage or degradation. These systems and methods will reduce waste, container usage, and shipping container volume, shipping costs, and also the reduce the number of different types of container materials required to maintain temperatures. Further, the products in the containers will have reduced damage from overheating or overcooling.

### DETAILED DESCRIPTION

Turning now to the drawings, in which like numerals represent like (but not necessarily identical) elements throughout the figures, example embodiments of the present technology are described in detail.

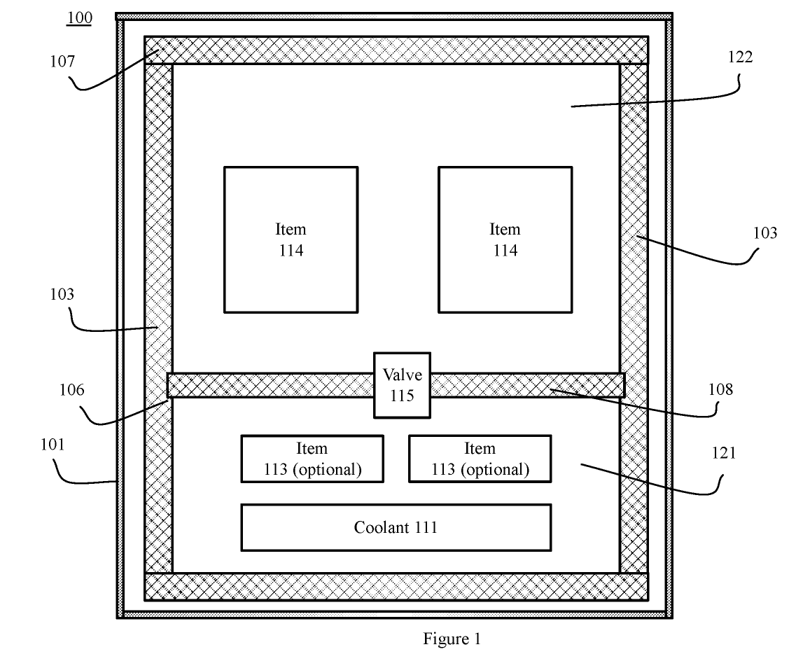

FIG. 1 is an illustration depicting a cross section of a side view of a delivery container with a coolant compartment 121 and a chilled compartment 122 separated by a panel having a valve disposed therein, in accordance with certain example embodiments.

In an example, a delivery organization receives an order to deliver one or more products to a user. In an example, the user has ordered products from a merchant to be delivered to the residence of the user. Alternatively, the delivery organization is the merchant and is delivering products sold by the delivery organization. Alternatively, the delivery organization receives products to ship from one user to a second user. The products ordered are indicated in FIG. 1 as one or more items 113 and one or more items 114.

In the example, the items 113 require cooling to less than 32 degrees F. but typically approximately 0 degrees F., the items 114 require cooling to less then 40 degrees F. and typically in a range bounded by 33 to 38 degrees F. These temperatures are only examples of typical temperature requirements for different products. In other examples, items 113 are not maintained in the coolant compartment 121, only in the chilled compartment 122. In other examples, other items are stored in a third compartment that does not require a specific temperature range. Any suitable temperature may be requested or utilized for the items 113, 114. In alternate examples, the items 113, 114 may require heating above ambient temperatures. Instead of coolants, the shipper may employ heating devices that will raise the temperature in the delivery container 100. The functions of the methods described herein may be applied to an environment requiring heating. Other examples may be directed to controlling other environmental factors, such as humidity.

In an alternate design, the coolant compartment 121 does not include items 113. That is, the coolant compartment cools the chilled compartment 122, but does not cool any items in the coolant compartment 121. The coolant compartment 121 would include only the coolant 111.

The delivery organization desires to deliver all the items 113, 114 in a single delivery container 100. In an example, the container 100 is a box that is substantially a cube. In another example, the container 100 is a rectangular prism. Any other suitably shaped container 100 may be used, such as a cylinder. The container wall 101 may be constructed of cardboard, foam, cellulose, metal, plastic, or any other suitable material. The container wall 101 may be constructed of a combination of materials, such as a plastic shell with a foam liner and foam panels. The materials may be selected based on the heat transfer properties of the materials. In an example, the container wall 101 is constructed of an insulating material, such as a foam material to reduce the heat flowing into the interior of the container 100. In an example, the materials are selected based on factors affecting the environmentally friendly nature of the material. For example, the materials may be selected because the materials are recyclable or are made from recycled materials.

In an example, the container 100 is composed of a cardboard container wall 101 with alternating layers of cardboard and a plastic film inside the container walls. The use of the term cardboard represents any recyclable or environmentally friendly material such as corrugated cardboard, cellulose, or any other material that is manufactured from a recyclable material or is recyclable itself. For example, the container 100 comprises a container 103 with a cardboard lid 107 for enclosing the coolant and items 113, 114. The container 103 may incorporate a plastic film, plastic bag, waterproof liner, or any suitable component for ensuring that the compartments 121, 122 are substantially airtight. The container 103 may be a series of panels that are assembled inside the container wall 101. Alternatively, the container 103 may be a fully formed box that is placed inside the container wall 101. Alternatively, the container 103 may be formed by two boxes that stack onto one another to form the two compartments 121, 122. Any other configuration may be employed to represent the container 103.

The compartments 121, 122 of the container 101 are configured to be substantially sealed and airtight. The compartments 121, 122 must be substantially airtight to allow the air in the compartments 121, 122 to be monitored and controlled with the valve 115 to maintain the temperatures.

The panel 108 and the lid 107 may be selected to reduce the heat flowing into the coolant compartment 121 of the container 100 from other compartments, such as from compartment 122 or from the environment. The panel 108 and lid 107 may be constructed of cardboard, foam, cellulose, metal, plastic, or any other suitable material. The panel 108 and lid 107 may be constructed of a combination of materials, such as a plastic shell with a foam liner and foam panels. The materials may be selected based on the heat transfer properties of the materials.

The lid 107 may be constructed in any manner to close and seal the box enclosing compartments 121, 122. For example, the lid 107 may be constructed or two or four flaps that are configured to fold down and be sealed with tape or any suitable sealant. The lid 107 may be a solid section made of a similar material as the sidewalls that slips onto the sidewalls of the container 103 and provides a seal. The lid 107 may be constructed of a different material than the container 103 to provide a desired amount of insulation. Any suitable lid 107 may be employed.

In an example, the panel 108 and lid 107 are constructed of an insulating material, such as a layered cardboard and plastic. The panel 108 may be affixed to the walls 101 of the container 100 by any suitable means. For example, the container wall 101 may have inset grooves 106 into which the panels may slide and thus be affixed to the walls of the container. The grooves 106 may be set at regular intervals to allow the size of the compartments 121, 122 to be varied as needs arise. Alternatively, the container wall 101 may have tabs, clips, or any other suitable connection that may be used to affix the panel 108 to the walls 101. The panel 108 is affixed in a position to allow for the size of the coolant 111. For example, if a greater volume of coolant 111 is required, then the panel 108 may be positioned higher up the container wall 101. Alternatively, the panel 108 may form an integrated top of a container 103 and thus may not be a separate panel.

The panel 108 includes a pressure relief valve 115 that passes through the panel 108. The valve 115 is typically a one-way valve that will open when the high pressure side has a pressure greater than the low pressure side. Typically, the pressure of the high pressure side must be more than a certain amount higher than the pressure of the low pressure side for the valve 115 to open. For example, the pressure may only force the valve 115 open when the high pressure side is 0.2, 1, or 5 pounds per square inch (“psi”) greater than the low side.

The coolant 111 cools the coolant compartment 121 to a lower temperature. The lower temperature may vary as the coolant 111 melts, warms, evaporates, sublimates, or otherwise loses its cooling effect. In the example, if the coolant 111 is water ice, the coolant compartment 121 is cooled to less than 32 degrees F., such as 0 degrees F. In another example, if the coolant 111 is dry ice, the coolant compartment 121 is cooled to less than 0 degrees F., such as −20 degrees F. The thickness and insulating capacity of the panels 107, 108 and the container walls 103, 101 may be varied to dictate the temperature in each compartment. The coolant 111 in the coolant compartment 121 causes the temperature in the chilled compartment 122 to decrease due to heat transfer between the conjoined or adjacent compartments 121, 122. That is, when heat transfers through the panel 108, the temperature in the chilled panel will decrease initially. The two compartments 121, 122 will reach an equilibrium after initially being placed in the container 101. However, the coolant 111 may not be sufficient to bring the temperature of the compartment 122 to the desired temperature, or the coolant 111 may not be sufficient to keep the temperature of the compartment 122 at the desired temperature. In these circumstances, the valve 115 serves to assist with maintaining the desired temperature.

As the coolant compartment 121 temperature lowers and/or the chilled compartment 122 temperature increases, the pressure difference between the coolant compartment 121 and the chilled compartment 122 increases. The pressure in each compartment 121, 122 is proportional to the temperature in each compartment 121, 122. When the difference of the temperatures of the two compartments 121, 122 increases, the difference in the pressures of the two compartments 121, 122 increases proportionally. When the pressure difference is greater than the set point of the valve 115, the valve 115 is forced open by the pressure in the chilled compartment 122.

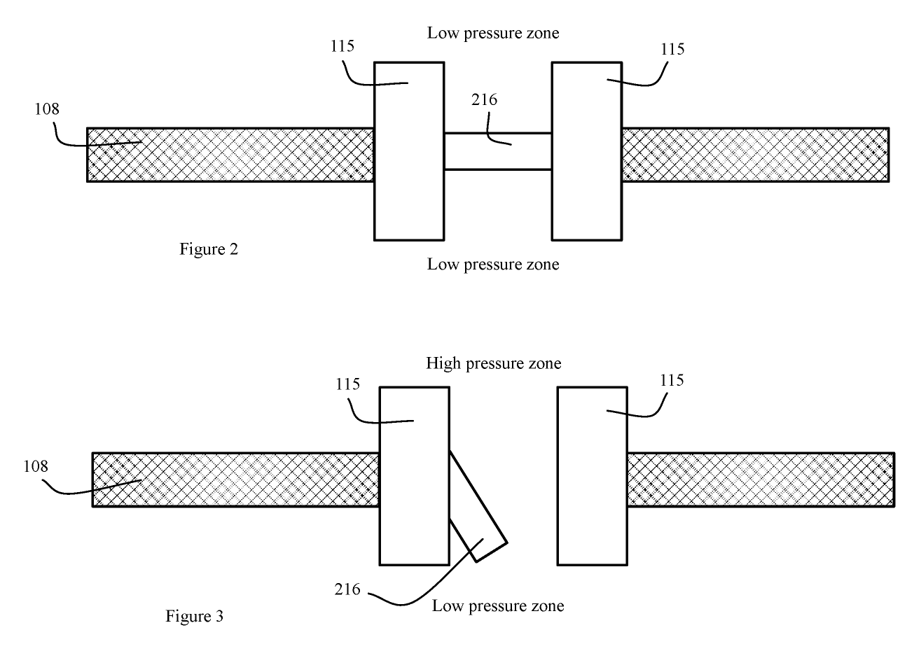

For example, the valve 115 may include a spring operated seal to prevent air flow when closed. The valve is shown in greater detail in FIGS. 2 and 3.

FIG. 2 is an illustration depicting across section of a valve in a closed state, in accordance with certain example embodiments. FIG. 3 is an illustration depicting across section of the valve in an open state, in accordance with certain example embodiments. The cross sections of the valve 115 in FIGS. 2 and 3 are shown penetrating the panel 108 that separates the chilled compartment 122 from the coolant compartment 121.

In FIGS. 2 and 3, for the purposes of clarity, a flapper style valve is shown. The valve 115 may include any configuration of spring, seat, and seal 416. For example, the valve 115 may include a poppet style valve stem, a flapper style seal, a disc seal, or any other suitable valve style that opens when exposed to a pressure differential. In the valve 115 depicted in FIGS. 2 and 3, a simple flapper 416 is provided to illustrate that the valve 115 opens to allow air to flow from the higher pressure side to the lower pressure side.

As depicted, the high pressure side in FIGS. 2 and 3 represents the chilled compartment 122 wherein the pressure increases as the temperature increases. The low pressure side in FIGS. 2 and 3 represents the coolant compartment 121 wherein the pressure decreases as the temperature decreases.

In the example, a spring or other force causes the valve to close to prevent air from flowing through the valve when the pressures in the low pressure side and the high pressure side are substantially equal. When the pressure difference between the two compartments 121, 122 is greater than the set pressure of the spring, the valve 115 is forced open and air flows through the valve 115. When the air flows from the high pressure side of the valve 115 to the low pressure side of the valve and the pressure equilibrates, the spring forces the valve 115 to close. Alternate types of valves 115 may not use a spring to close the valve 115. For example, the valves 115 may use a gasket or other material to seal the valve 115 and open under pressure.

When the temperature in the chilled compartment 122 rises to a desired temperature, the pressure proportionally rises to a desired pressure and forces open the valve 115, as described herein. When open, the valve 115 allows air to flow through the valve 115. Initially, the air from the chilled compartment 122 flows through to the coolant compartment 121 reducing the pressure and thus the temperature of the chilled compartment 122. As the valve 115 typically takes some amount of time to reclose, a flow of cooler air from the coolant compartment 121 flows into the chilled compartment 122 and exchanges heat with the air in the chilled compartment 122 causing the chilled compartment 122 temperature to further cool.

When the pressure of the chilled compartment 122 reaches an equilibrium state with the coolant compartment 121, the valve 115 closes. The temperature of the chilled compartment 122 has been chilled to a desired temperature based on the speed of the closure of the valve 115. A faster closing valve 115 will allow a smaller exchange of air and heat between the compartments and a lesser reduction in the heat of the chilled compartment 122. A valve 115 that takes a longer time to close will allow for a greater exchange of air and will cause the temperature in the chilled compartment 122 to be cooled to a relatively lower temperature.

In testing, the valve 115 is able to control a temperature range in the chilled compartment 122 as low as 4 to 5 degrees F. That is, the temperature when the valve 115 opens is 4 to 5 degrees higher than after the valve 115 closes. For example, the temperature of the chilled compartment 121 may be maintained for an extended period of time between 33 and 38 degrees F.

Returning to FIG. 1, the container 100 is sized to hold all of the items 113, 114 or a selected portion of the items 113, 114. Based on the items that are to be shipped at different temperatures, the delivery organization configures the panels 108 and the size of the container 103 being placed in the container 100.

In an alternate example, a panel 108 is not used, but instead container 103 is formed by two separate boxes. That is, a first container 103 may be placed in the container 101 to form compartment 121, and a second box is placed on top of the first box to form compartment 122. Similarly, a third box may be placed on the second box to form a third compartment.

The appropriate coolant 111 to control the temperature in each compartment 121, 122 is placed into the container 100. The coolant 111 required may be based on factors such as the mass and the thermal conductivity of the products 113, 114 in the compartments 121, 122, the ambient temperature, the amount of time that delivery is expected to take, the thickness of the components of the container 100, the material of the components of the container 100, and any other suitable factors. Based on these factors, the delivery organization selects an appropriate coolant 111 and a particular amount of coolant 111. A larger amount of coolant 111 may cause a lower temperature to be maintained, the temperature to be maintained for a longer period of time, or both. Certain types coolant 111 may cause the temperature to be lower than another coolant. For example, dry ice (solid carbon dioxide) may cause the temperature in the compartments 121, 122 to be lower than the temperature caused by water ice.

In the example, compartment 121 is selected to store the one or more items 113 at less than 32 degrees F. but approximately 0 degrees F. In the example, based on the size of the items 113, the expected delivery time, the insulation properties of the container 100 and the other components, the ambient temperature, and any other suitable factors, the coolant 111 selected for use is dry ice. Any other suitable coolant may be selected that will cool the compartment 121 to an appropriate temperature.

The coolant 111 is placed in the bottom of the container 100. The items 113 are placed in the compartment 121 with the coolant 111. In an example, the coolant 111 is in a package or other material that prevents contact of the items 113 with the coolant. For example, the coolant 111 may be covered with a tray, a plastic cover, a section of fabric, or any other material or structure to protect the item 113 from contacting the coolant 111 directly. Alternatively, the items 113 may be affixed to the wall of the first cardboard container 106 in any suitable manner. For example, the items 113 may be affixed to the wall of the first cardboard container 106, wrapped in bubble wrap, placed in packing foam, or suspended in packing material.

The panel 108 is placed over the coolant 111. The panel 108 may be affixed to the walls 101 of the container 100 by any suitable means. For example, the container wall 101 may have inset grooves 106 into which the panels may slide and thus be affixed to the walls of the container. The grooves 106 may be set at regular intervals to allow the size of the compartments 121, 122 to be varied as needs arise. Alternatively, the container wall 101 may have tabs, clips, or any other suitable connection that may be used to affix the panel 108 to the walls 101. The panel 108 is affixed in a position to allow for the size of the coolant 111. For example, if a greater volume of coolant 111 is required, then the panel 108 may be positioned higher up the container wall 101.

In the example, compartment 122 is selected to store the one or more items 114 below 40 degrees F., such as approximately 33-38 degrees F. Based on the size of the items 114, the expected delivery time, the ambient temperature, and any other suitable factors, the delivery organization may select insulation properties of the container 100, the container 103, the panel 108, and the top panel 107, the size of the compartment 122, the size and placement of the valve 115, and other suitable factors to achieve the desired temperature in compartment 122.

After affixing the panel 108, the items 114 may be placed in the compartment 122. The items 114 may rest on the panel 108 that is over the coolant 111. The items 114 may be affixed to the wall of the first cardboard container 106 in any suitable manner. For example, the items 114 may be affixed to the wall of the first cardboard container 106, wrapped in bubble wrap, placed in packing foam, or suspended in packing material.

A top panel 107 is placed on the container 103 to close or seal the container 103. The top panel 107 may be any type of lid or top that can close the container 100 for shipping. The top panel 107 may be a separate panel that fits snuggly over the lip of the wall of the container 103. The top panel 107 may be a panel that is connected on one side to the wall of the container 103 and folds over to seal the container 103. The top panel 107 may be a separate panel that fits snuggly inside the wall of the container 103, such as in a groove in the container wall 101. Any type of top panel 107 may be used to close or seal the container 103. The container 103 may be sealed shut with tape, glue, or any other suitable sealing material.

The temperature of the compartment 122 is cooled through the panel 108, and the temperature is controlled by the valve 115 as described herein.

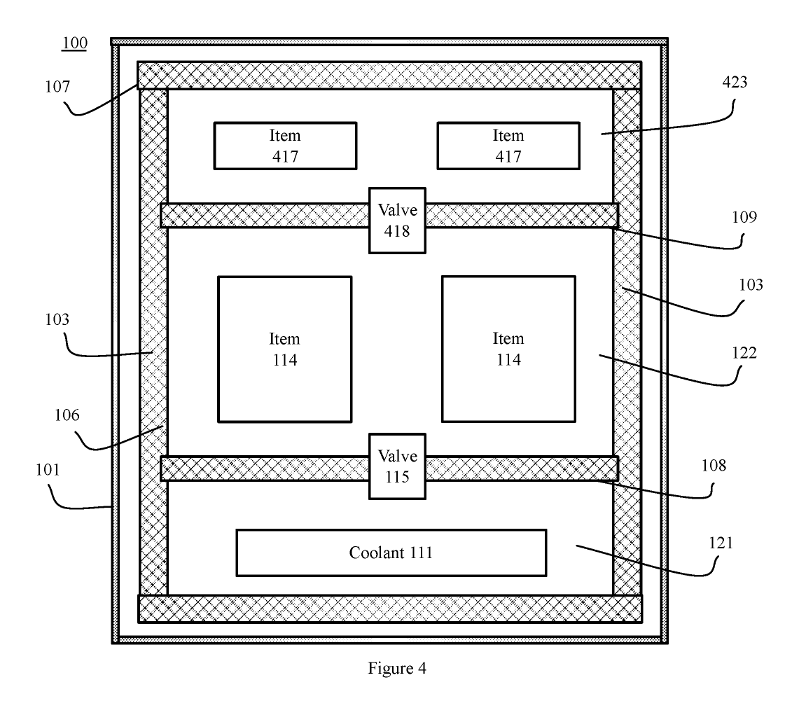

FIG. 4 is an illustration depicting a cross section of a side view of a delivery container 101 with a coolant compartment 121 and two chilled compartments 122, 423, with the compartments separated by panels that each have a valve disposed therein, in accordance with certain example embodiments.

The container 101 may have multiple chilled compartments 122, 423, such as a compartment 121 for the coolant 111, a compartment 122 for frozen items 114, and a compartment 423 for refrigerated items 417. The container may include two valves 115, 418 for maintaining the temperature in each respective compartment 122, 423. For example, a valve 115 between a coolant compartment 121 and the first compartment 122 may maintain the temperature of the first compartment 122 at 0-6 degrees F. A second valve 418 between the first compartment 122 and the second compartment 423 maintains the temperature in the second compartment 423 at 33-38 degrees F. The two valves 115, 418 in this configuration operate substantially the same as the examples herein using a single valve 115, as described in FIG. 1.

The second valve 418 is positioned in a panel 109 that is configured substantially the same as panel 108. That is, panel 109 is positioned in the container 103 to split the container 103 into two compartments 122, 423. The second valve 418 has a higher pressure side open to the compartment 423 and a lower pressure side open to compartment 122. Similar to the method described in FIG. 1-3 with respect to valve 115, the temperature in the higher temperature compartment 423 causes the valve 416 to open. The open valve 418 allows the warmer air from compartment 423 to flow into compartment 122 to cause the pressure difference to drop and to allow the valve 416 to close. The pressure reduction and the mixing of air from compartment 122 and compartment 423 causes the temperature in compartment 423 to be lowered to a desired temperature. The compartment 423 is thus controlled within a specific temperature range.

The two valves 115, 416 may create a cascade effect to cause the temperatures in the compartments 122, 423 to be controlled in the desired temperature range. In an example, the coolant compartment 121 may cool the first chilled compartment 122 to a range, such as 0-6 degrees F. The cold air in this compartment 122 similarly cools the second compartment 423 to a temperature range of 33-38 degrees F. This would allow items 114 in the first compartment 122 to remain frozen while the items 417 in the second compartment 423 are merely refrigerated.

The container 100 is delivered to the desired user with the cooled items inside. Upon arrival, the items in the compartments are at the desired temperatures as specified in the examples herein. The user receiving the container 101 may unpack the items from the container 100 and store the items in an appropriate cooled environment.

In the example, the components of the container 100, such as the container 103, the container walls 101, the panels 107, 108, and any other appropriate components may be recycled or disposed of in any appropriate manner. The valve 115 may be removed and reused by the user or returned to the delivery organization for reuse. The valve 115 may be recycled or disposed of in any appropriate manner.

In an alternate example, the valve 115 performs as described herein with the intent to maintain the temperature of the coolant compartment 121. That is, the exchange of air with the chilled compartment 122 causes the temperature of the coolant compartment 122 to rise via the exchange of warmer air from the chilled compartment 122. Thus, while the temperature of the chilled compartment 122 is controlled as described herein, the temperature in the coolant compartment 121 is being similarly controlled. Typically, the temperature of the coolant compartment 121 is warmed to keep the temperature from being too low. That is, when the temperature of the coolant compartment 121 decreases, the pressure difference drops proportionally below the valve set point and the valve 115 opens to warm the coolant compartment 121. The temperature of the coolant compartment 121 is accordingly maintained within a desired range.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the inventions described herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

What is claimed is:

1. A container assembly with multiple temperature compartments, comprising:
a first compartment in a container, the first compartment being formed by a bottom surface, four side walls, and a first top surface;
a second compartment in the container, the second compartment being formed by four side walls, a second top surface, and the first top surface of the first compartment, such that the first compartment is adjacent with the second compartment;
a coolant disposed in the first compartment; and
a pressure relief valve disposed between the first and second compartments such that a high pressure side of the pressure relief valve is positioned in the second compartment and a low pressure side of the pressure relief valve is positioned in the first compartment, wherein the pressure relief valve operates to control a temperature in the second compartment by opening to relieve pressure from the second compartment to the first compartment at a predetermined pressure difference between the second compartment and the first compartment.

2. The container assembly of claim 1, wherein a temperature of the second compartment is cooled by a configured temperature during a period when the pressure relief valve is open.

3. The container assembly of claim 1, wherein the pressure relief valve further operates to control the temperature of the second compartment by closing at a rate that allows an exchange of air from the first compartment having the coolant therein to the second compartment.

4. The container assembly of claim 1, further comprising:
a third compartment in the container, the third compartment being formed by four side walls, a third top surface, and the second top surface, such that the second compartment is adjacent with the third compartment; and
a second pressure relief valve disposed between the second and third compartments such that a high pressure side of the second pressure relief valve is positioned in the third compartment and a low pressure side of the second pressure relief valve is positioned in the second compartment, wherein the second pressure relief valve operates to control a temperature in the third compartment by opening to relieve pressure from the third compartment to the second compartment at a predetermined pressure difference between the second compartment and the third compartment.

5. The container assembly of claim 1, wherein the temperature in the second compartment is lowered when the pressure relief valve is opened due to a combination of a reduction in the pressure in the second compartment and an exchange of air from the first compartment having the coolant therein to the second compartment.

6. The container assembly of claim 1, wherein the pressure relief valve operates to control the temperature of the second compartment within a predetermined range of temperature above freezing.

7. The container assembly of claim 1, wherein the pressure in the second compartment increases while the pressure relief valve is closed due to the temperature of the second compartment increasing because of heat exchange through the second compartment side walls and top surface.

8. The container assembly of claim 1, wherein the pressure relief valve is positioned in the first top surface.

9. The container assembly of claim 1, wherein the container forms a rectangular prism.

10. The container assembly of claim 1, wherein the first top surface of the first compartment is positioned such that the first compartment and the second compartment are of different sizes.

11. The container assembly of claim 1, wherein the first top surface of the first compartment is constructed of an insulating material.

12. The container assembly of claim 1, wherein the coolant is dry ice.

13. The container assembly of claim 1, wherein the coolant is water ice.

14. The container assembly of claim 1, wherein the coolant is selected based on an ambient temperature, desired temperatures of the first and second compartments, and an expected time for maintaining the temperature of the second compartment at or below a desired temperature.

15. The container assembly of claim 1, wherein materials of the compartments are determined based on an ambient temperature, a desired temperature of the first and second compartments, and an expected time until delivery.

16. The container assembly of claim 1, wherein materials of the container and the compartment are selected from plastic, cardboard, or foam.

17. A method to assemble and pack a container assembly to store items requiring cooling, comprising:
receiving at least one item, the item requiring a temperature range for storage;
selecting an appropriately sized container with an outer container wall forming a bottom surface and four side walls;
positioning a first compartment in the container;
positioning a second compartment in the container adjacent to the first compartment;
depositing a coolant placed in the first compartment, the coolant having cooling characteristics to maintain a temperature of the first compartment at or below a first temperature; and
positioning a pressure relief valve mounted such that a high pressure side of the pressure relief valve is positioned in the second compartment and the low pressure side of the pressure relief valve is positioned in the first compartment, wherein the pressure relief valve is operable to relieve pressure from the second compartment to the first compartment at a predetermined pressure difference between the second compartment and the first compartment, and wherein the pressure relief valve is operable to close at a second predetermined pressure difference between the second compartment and the first compartment.

18. The method of claim 17, wherein the temperature of the second compartment is cooled to a second configured temperature during a period when the pressure relief valve is open.

19. The method of claim 17, wherein the pressure relief valve is configured to allow an exchange of air from the second compartment and the first compartment.

20. The method of claim 17, wherein the temperature in the second compartment is lowered when the pressure relief valve is opened due to a combination of a reduction in the pressure in the second compartment and an exchange of air with the first compartment.
